(19) United States
(12) Patent Application Publication
(10) Pub. No.: US 2009/0174506 A1
(43) Pub. Date: Jul. 9, 2009

(54) WAVEGUIDE AND METHOD FOR ADJUSTING WAVEGUIDE STRUCTURE THEREOF

(75) Inventor: CHIH JUNG LIN, HSINCHU CITY (TW)

Correspondence Address: WPAT, PC;INTELLECTUAL PROPERTY ATTORNEYS, 2030 MAIN STREET, SUITE 1300, IRVINE, CA, 92614, US

(73) Assignee: MICROELECTRONICS TECHNOLOGY INC., HSINCHU (TW)

(21) Appl. No.: 12/122,281

(22) Filed: May 16, 2008

(30) Foreign Application Priority Data
Jan. 9, 2008 (TW) 097100775

(51) Int. Cl. H01P 1/165; H01P 5/12

(52) U.S. Cl. 333/21 A; 333/137

(57) ABSTRACT

A waveguide comprises a connecting part, a main chamber and a buffer. The connecting part is connected to the main chamber via the buffer. The side length of the junction between the connecting part and the buffer is smaller than that of the junction between the buffer and the main chamber.

### BACKGROUND OF THE INVENTION

(A) Field of the Invention

The present invention relates to a waveguide, and more particularly, to a method for adjusting the structure of a waveguide to improve the quality of transmitting and receiving signals thereof.

(B) Description of the Related Art

Waveguides are usually utilized in satellite communication to connect antenna and signal processing units, which execute signal processing of transmitting and receiving satellite signals. A circular polarized waveguide is composed of a splitter and a polarizer. The splitter divides transmitting satellite signals with the same phase into vertical and horizontal parts. The polarizer further shifts the vertical and horizontal satellite signals into satellite signals with phase difference of 90 degrees.

Conventional circular polarized waveguides with corrugated structure applied in Ka band often have spikes in the frequency response of their transmitting signals and therefore the quality of their transmitting signals is affected. In addition, the quality of the receiving signals is also affected due to the reflecting signals of the waveguides. Therefore, there is a need to design a method to adjust the structure of waveguides to improve the quality of transmitting and receiving signals.

### SUMMARY OF THE INVENTION

The first embodiment of the present invention is a waveguide comprising a connecting part, a main chamber and a buffer. The buffer connects the connecting part and the main chamber. The side length of the junction between the connecting part and the buffer is smaller than that of the junction between the buffer and the main chamber.

The second embodiment of the present invention is a method for adjusting the structure of a waveguide to improve the quality of its transmitting and receiving signals comprising the step of reducing a first side length of the junction between the connecting part and the buffer so that the first side length is shorter than a second side length of the junction between the main chamber and the buffer.

### BRIEF DESCRIPTION OF THE DRAWINGS

The objectives and advantages of the present invention will become apparent upon reading the following description and upon reference to the accompanying drawings in which:

FIG. 1A shows a part of the top view of a waveguide of the first embodiment of the present invention;

FIG. 1B shows a front view of a waveguide of the first embodiment of the present invention;

FIG. 1C shows a side view of a waveguide of the first embodiment of the present invention;

FIG. 2A shows a transmitting frequency response of the first embodiment of the present invention;

FIG. 2B shows another transmitting frequency response of the first embodiment of the present invention;

FIG. 2C shows yet another transmitting frequency response of the first embodiment of the present invention;

FIG. 3 shows a receiving frequency response of the first embodiment of the present invention; and

FIG. 4 shows a method for adjusting the structure of a waveguide to improve the quality of its transmitting and receiving signals of the second embodiment of the present invention.

### DETAILED DESCRIPTION OF THE INVENTION

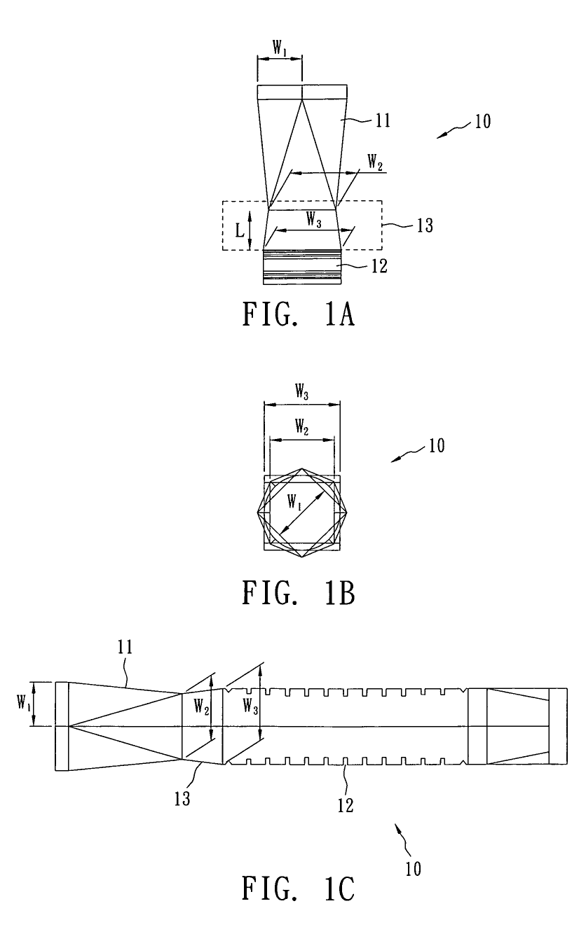

FIG. 1A shows a part of the top view of a waveguide 10 of the first embodiment of the present invention. FIG. 1B shows a front view of the waveguide 10. FIG. 1C shows a side view of the waveguide 10. The waveguide 10 comprises a connecting part 11, a main chamber 12 and a buffer 13. The connecting part 11 is a power splitter connecting to a signal processing unit to divide transmitting satellite signals having the same phase into vertical and horizontal parts. The main chamber 12 is a dual-band polarizer with corrugated structure to shift the vertical and horizontal satellite signals into satellite signals with phase difference of 90 degrees being transmitted to an antenna. The buffer 13 connects the connecting part 11 and the main chamber 12. As can be shown in FIG. 1, the side length of the opening end of the connecting part 11 is W₁. The side length of the junction between the connecting part 11 and the buffer 13 is W₂. The side length of the junction between the buffer 13 and the main chamber 12 is W₃. The length of the buffer 13 is L.

The waveguide 10 exhibits a high frequency transmitting band and a low frequency receiving band. To solve the problem of the spikes induced in the transmitting band of the waveguide 10, W₂ is shortened in the first embodiment of the present invention to keep the spikes away from the transmitting frequency response.

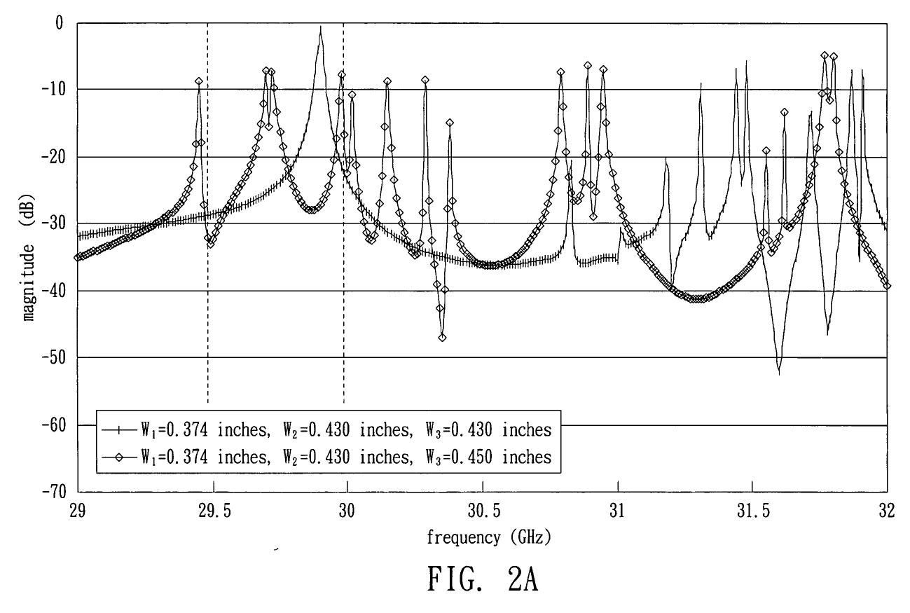

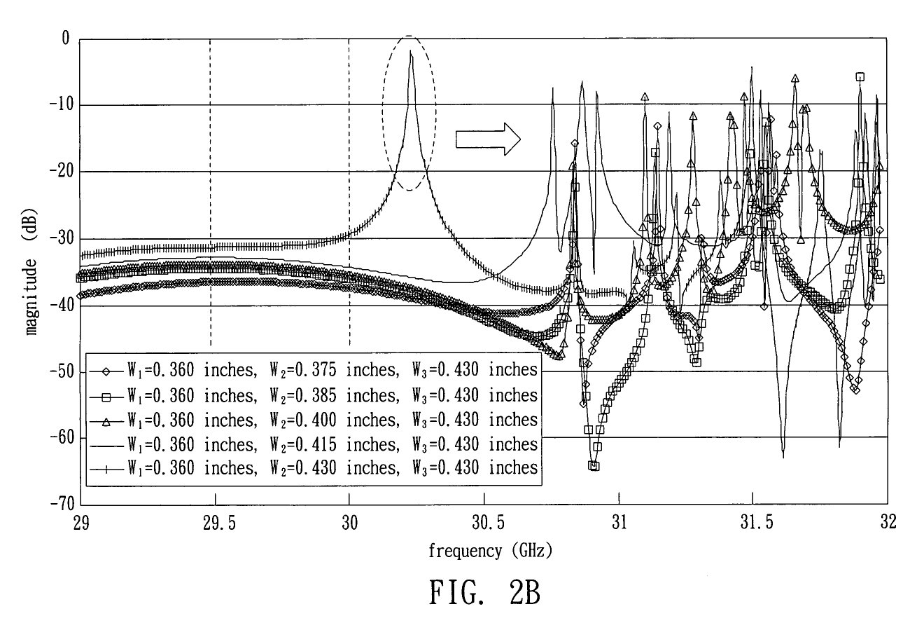

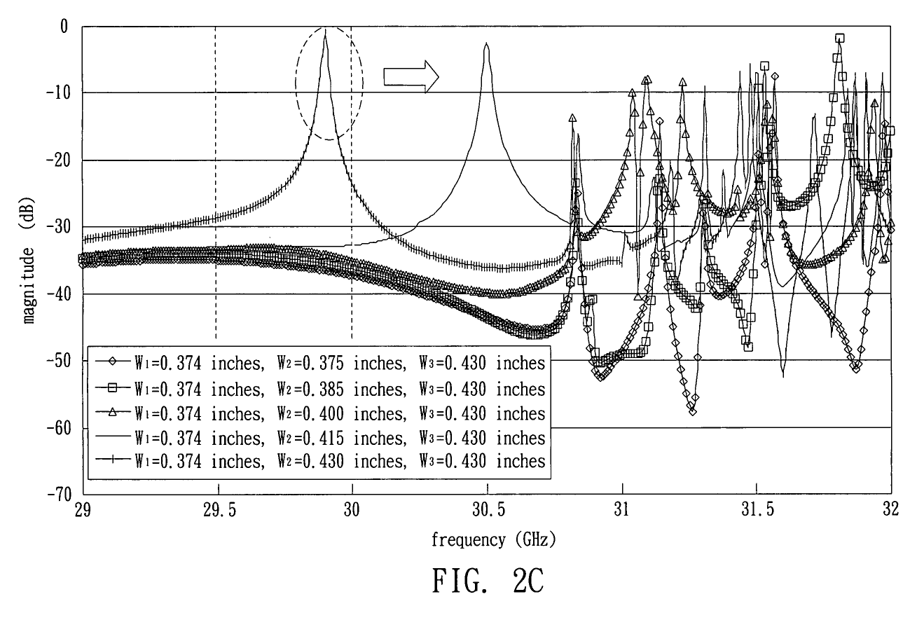

FIG. 2A shows a transmitting frequency response of the first embodiment of the present invention. As shown in FIG. 2A, when W₁ is fixed at 0.374 inches and W₂ is fixed at 0.43 inches, as W₃ becomes shorter, fewer spikes are induced in the transmitting band of the waveguide 10. Preferably, W₃ is between 0.425 and 0.435 inches.

FIG. 2B shows another transmitting frequency response of the first embodiment of the present invention. As shown in FIG. 2B, when W₁ is fixed at 0.36 inches and W₃ is fixed at 0.43 inches, as W₂ becomes shorter, the spikes induced become farther away from the transmitting band of the waveguide 10. Preferably, the ratio of W₂ to W₁ is smaller than 1.2.

FIG. 2C shows yet another transmitting frequency response of the first embodiment of the present invention. As shown in FIG. 2C, when W₁ is fixed at 0.374 inches and W₃ is fixed at 0.43 inches, as W₂ becomes shorter, the spikes induced become farther away from the transmitting band of the waveguide 10. Preferably, the ratio of W₂ to W₁ is smaller than 1.07.

On the other hand, to improve the quality of the receiving signals affected by the reflecting signals of the waveguide 10, W₁ is lengthened in the first embodiment of the present invention to reduce the proportion of the reflecting signals in the receiving band.

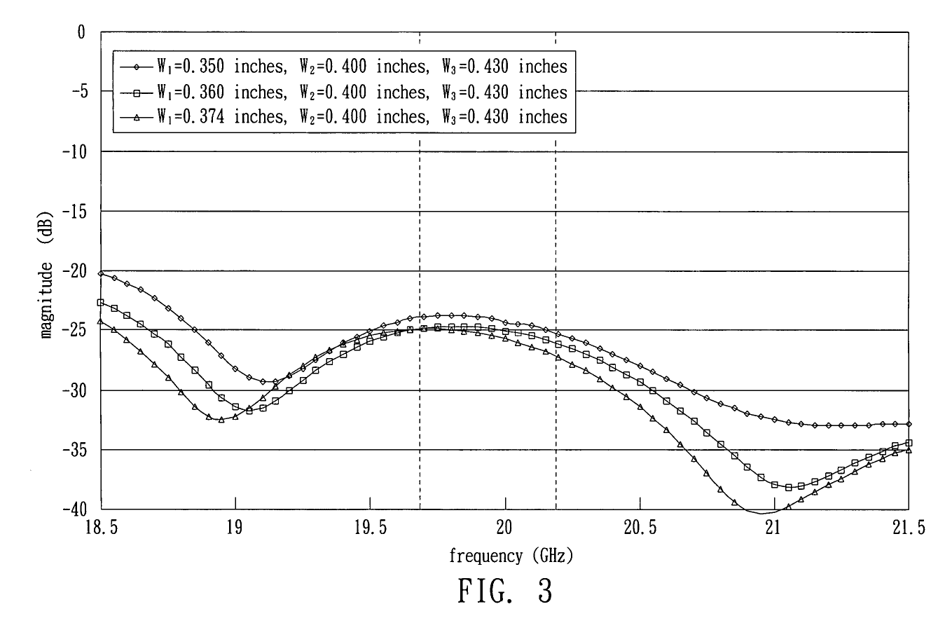

FIG. 3 shows a receiving frequency response of the first embodiment of the present invention. As shown in FIG. 3, when W₂ is fixed at 0.4 inches and W₃ is fixed at 0.43 inches, as W₁ becomes longer, the receiving frequency response becomes better. Preferably, W₁ is between 0.35 and 0.375 inches.

As can be seen from FIG. 1A to FIG. 3, when applied in K and Ka bands, the waveguide 10 of the first embodiment of the present invention can effectively improve the conventional waveguides and enhance their transmitting and receiving qualities.

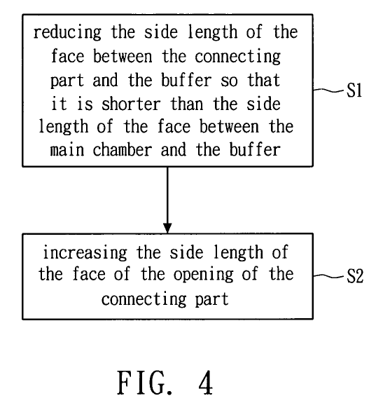

FIG. 4 shows a method for adjusting the structure of a waveguide to improve the quality of its transmitting and receiving signals of the second embodiment of the present invention. The waveguide includes a connecting part connected to a main chamber via a buffer. The connecting part is a power splitter and is connected to a signal processing unit. The main chamber is a polarizer and is connected to a signal processing unit. In Step S1, the side length of the junction between the connecting part and the buffer is reduced so that it is shorter than that of the junction between the main chamber and the buffer. In Step S2, the side length of the opening end of the connecting part is increased.

The cross-junction of the waveguide of the present invention is not limited to a square shape as in the first embodiment, but can also include all kinds of shapes such as triangular shape, hexagonal shape, circular shape, and so on.

The above-described embodiments of the present invention are intended to be illustrative only. Those skilled in the art may devise numerous alternative embodiments without departing from the scope of the following claims.

What is claimed is:

1. A waveguide comprising:
a connecting part;
a main chamber; and
a buffer connecting the connecting part and the main chamber;
wherein a side length of the junction between the connecting part and the buffer is smaller than a side length of the junction between the buffer and the main chamber.

2. The waveguide of claim 1, wherein the ratio of the side length of the junction between the connecting part and the buffer to a side length of an opening end of the connecting part is smaller than 1.2.

3. The waveguide of claim 1, wherein the ratio of the side length of the junction between the connecting part and the buffer to a length of an opening end of the connecting part is smaller than 1.07.

4. The waveguide of claim 1, wherein a side length of an opening end of the connecting part is between 0.35 to 0.375 inches.

5. The waveguide of claim 1, wherein the side length of the junction between the main chamber and the buffer is between 0.425 to 0.435 inches.

6. The waveguide of claim 1, wherein the connecting part is a power splitter.

7. The waveguide of claim 1, wherein the connecting part is connected to a signal processing unit.

8. The waveguide of claim 1, wherein the main chamber is a polarizer.

9. The waveguide of claim 1, wherein the main chamber is connected to an antenna.

10. The waveguide of claim 1, wherein the main chamber is a dual-band corrugated polarizer.

11. The waveguide of claim 1, which is applied to Ka band.

12. The waveguide of claim 1, which is applied to K band.

13. The waveguide of claim 1, wherein the junctions are in a square form.

14. A method for adjusting a waveguide structure to improve the quality of its transmitting and receiving signals, wherein the waveguide includes a connecting part connected to a main chamber via a buffer, the method comprising the step of:
reducing a first side length of the junction between the connecting part and the buffer so that the first side length is shorter than a second side length of the junction between the main chamber and the buffer.

15. The method of claim 14, further comprising the step of:
increasing a third side length of an opening end of the connecting part.

16. The method of claim 14, wherein the ratio of the first side length of the junction between the connecting part and the buffer to a third side length of an opening end of the connecting part between 1 to 1.2.

17. The method of claim 14, wherein the connecting part is a power splitter.

18. The method of claim 14, wherein the main chamber is a polarizer.

19. The method of claim 14, wherein the connecting part is connected to a signal processing unit.

20. The method of claim 14, wherein the main chamber is connected to an antenna.
